(19) United States
(12) Patent Application Publication
(10) Pub. No.: US 2008/0261185 A1
(43) Pub. Date: Oct. 23, 2008

(54) SIMULATED TEACHING ENVIRONMENT

(75) Inventors: Ruby Payne, Corpus Christi, TX (US); Nancy Sturm, Triadelphia, WV (US); Damian Piccolo, Florence, KY (US)

Correspondence Address: HAYNES AND BOONE, LLP, 901 Main Street, Suite 3100, Dallas, TX, 75202, US

(73) Assignee: aha! Process, Incorporated, Highlands, TX (US)

(21) Appl. No.: 12/105,937

(22) Filed: Apr. 18, 2008

Related U.S. Application Data
(60) Provisional application No. 60/912,583, filed on Apr. 18, 2007.

(51) Int. Cl. G09B 9/00

(52) U.S. Cl. 434/219; 434/308; 703/22

(57) ABSTRACT

Embodiments of the disclosure may provide a method, system, and computer program configured to simulate a teaching environment for educational training. The method may include displaying an empty simulated classroom environment for an orientation period, displaying an occupied classroom environment for at least one classroom period, generating and displaying a plurality of events, both disruptive and non-disruptive during the at least one classroom period, identifying at least one of the plurality disruptive or non-disruptive events on a display, addressing the at least one identified event, scoring training performance for the simulated teaching environment based on the identifying and addressing actions, and using a score representative of the training performance to add enhancements to a subsequent teaching simulation.

This application claims the benefit of the filing date of U.S. provisional patent application Ser. No. 60/912,583, attorney docket no. 30396.48, filed on Apr. 18, 2007.

### BACKGROUND

Education is a fundamental element of American society. Education is continually a foundational issue in politics, budget making issues, and most importantly, in American family life. As such, our society makes diligent efforts to supply teachers with the tools required to provide a solid education for our youth. These tools include building new schools at record rates, providing modern classroom technology and current textbooks, hiring well qualified teachers, etc.

However, one area where many teachers, especially new teachers or teachers who only have experience in small group classroom environments, are lacking experience or training is in classroom management skills. For example, although teachers are generally experienced and qualified to teach various subjects or educational material, they often have little or no formal training in the skills required to manage a classroom of students. More particularly, although formal education and teaching skills are critical to a teacher's success, they are not enough, as the failure to identify and properly manage a small number of classroom events can easily detract from a teacher's ability to teach all of the students in the classroom.

Therefore, there is a need in the art for a method, apparatus, or computer program that is configured to simulate a teaching environment for use in training teachers to manage classroom events, such that the teacher's ability to manage the educational environment of the classroom is maximized for all of the students in a class.

### SUMMARY OF THE DISCLOSURE

Embodiments of the disclosure may provide a method for simulating a teaching environment for educational training. The method may include displaying an empty simulated classroom environment for an orientation period, displaying an occupied classroom environment for at least one classroom period, generating and displaying a plurality of disruptive events during the at least one classroom period, identifying at least one of the plurality disruptive events on a display, addressing the at least one identified disruptive event, scoring training performance for the simulated teaching environment based on the identifying and addressing actions, and using a score representative of the training performance to add enhancements to a subsequent teaching simulation.

Embodiments of the invention may further provide a computer program configured to control a teaching simulation, where the simulation includes a plurality of steps. The steps may include displaying an empty simulated classroom environment for an orientation period, displaying an occupied classroom environment for at least one classroom period, generating and displaying a plurality of disruptive events during the at least one classroom period, identifying at least one of the plurality disruptive events on a display by selecting the identified disruptive event with a pointing device, addressing the at least one identified disruptive event with a rule, procedure, or enhancement element, scoring training performance for the simulated teaching environment based on the identifying and addressing actions, and using a score representative of the training performance to add additional enhancement elements to a subsequent teaching simulation.

Embodiments of the invention may further provide a system for generating a simulated teaching environment for teacher training. The system may include a computer processor, a display in communication with the processor, a pointing device in communication with the processor, at least one memory element configured to store digital data, and a computer program stored on the at least one memory element and configured to be executed by the computer processor to control the teaching simulation. The teaching simulation may generally include displaying an interactive simulated classroom on the display, randomly generating disruptive events for display; receiving an input indicating a user's identification of the randomly generated disruptive events, receiving an input from the user indicating an action selected in response to the identified disruptive event, and calculating a user score based upon the number of disruptive events identified verses the number of disruptive events that were not identified by the user and the corrective action selected by the user in response to the identified disruptive events.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates an exemplary computer system that may be used to implement embodiments of the invention;

FIG. 2 illustrates a screen shot of an exemplary starting screen for the simulation program of the invention;

FIG. 3 illustrates a screen shot of an exemplary classroom period screen for the simulation program of the invention;

FIG. 4 illustrates a screen shot of an exemplary classroom period screen for the simulation program of the invention with an external disruptive event in process;

FIG. 5 illustrates a screen shot of an exemplary classroom period screen for the simulation program of the invention with a disruptive event noted on the teacher's computer monitor;

FIG. 6 illustrates a screen shot of an exemplary classroom period screen for the simulation program of the invention with a disruptive event caused by a student being shown;

FIG. 7 illustrates a screen shot of an exemplary classroom period screen for the simulation program of the invention after the user has selected/identified a disruptive event and is presented with responsive options;

FIG. 8 illustrates a screen shot of an exemplary classroom period screen for the simulation program of the invention where the user has selected to respond to a disruptive event with a one time procedure (as shown in FIG. 7);

FIG. 9 illustrates a screen shot of an exemplary classroom period screen for the simulation program of the invention where the user has selected to respond to a disruptive event by making a rule (as shown in FIG. 7) to address similar future disruptive events;

FIG. 10 illustrates a screen shot of an exemplary classroom simulation summary;

FIG. 11 illustrates a screen shot of an exemplary classroom store where the user is provided the opportunity to purchase items that will assist with the teaching process in the simulated classroom environment;

FIG. 12 illustrates a flowchart of an exemplary classroom simulation method of the invention.

### DETAILED DESCRIPTION

It is to be understood that the following disclosure provides several different embodiments or examples for implementing different features of various exemplary embodiments of the invention. Although some specific examples of components, arrangements, configurations, etc. are described below to simplify the present disclosure, these examples and exemplary embodiments are, of course, merely examples and are not intended to be limiting upon the scope of the invention. Additionally, the present disclosure may repeat reference numerals and/or letters in the description or figures related to the various exemplary embodiments of the invention. However, this repetition is for the purpose of simplicity and clarity and does not in itself dictate a relationship between the various exemplary embodiments and/or configurations described herein. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

The same applies for method steps, procedures, and processes herein, i.e., the order of the steps or processes illustrated in exemplary embodiments is not intended to be limiting in that additional steps may be interstitially inserted or positioned without departing from the scope of the invention. Further, unless specifically recited in a claim, where method steps or processes are described, embodiments of the invention are not intended to be limited to any particular order of method steps, as variations on the exemplary step or process sequences are contemplated within the scope of the invention.

Additionally, in the following, reference is made to various embodiments of the invention. However, it should be understood that the invention is not limited to any of the specifically described embodiments. Rather, the invention may include any combination of the features and elements described in the various exemplary embodiments, whether related to different embodiments or not. Furthermore, in various exemplary embodiments, the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered express elements or limitations of the appended claims, except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention may be implemented as a program product for use with a computer system or other data or instruction processing-type system, device, or apparatus. The program(s) of the program product may define functions of the embodiments (including the methods described herein) and may be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive, hard-disk drives, writable CD-ROM drives, tape drives, and any other writable computer storage medium known in the art); or (iii) information conveyed to a computer by a communications medium, such as through a network, including wireless communications. The latter embodiment specifically includes information transmitted to/from the Internet and/or other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically includes a multitude of instructions that will be translated by the native computer into a machine-readable format, and hence the instructions are transformed into executable instructions. Also, programs generally include variables and data structures that either reside locally to the program or are found in memory or on storage devices in communication with the computer system or processor.

Additionally, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

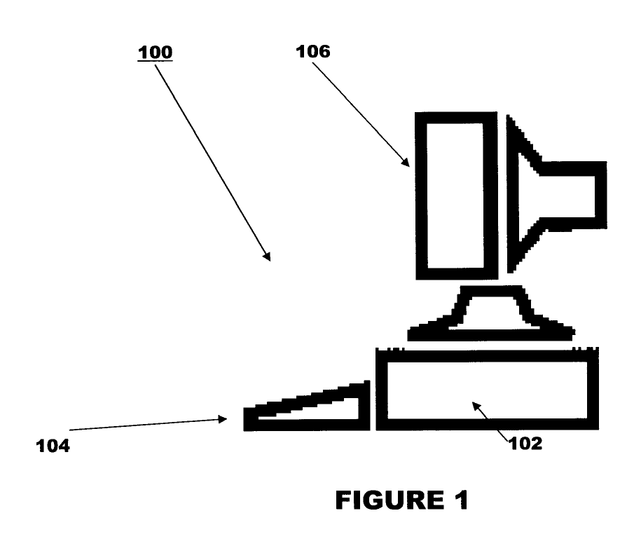

FIG. 1 illustrates an exemplary computer system that may be used to implement embodiments of the invention. The computer system 100 may be any type of computer system (IBM PC, MAC, etc.). The computer system 100 generally includes a processing unit 102, an input device 104, and an output device 106. The processing unit 102 may include micro processor in communication with at least one memory device, such as a hard disk drive, a type of random access memory, or other computer readable storage medium. At least one of the memory devices in the processing unit 102 may generally be configured to store a computer program thereon in manner such that the program may be retrieved therefrom and executed by a processor in accordance with the computer program's instructions. The input device 104 may be a keyboard, mouse, touch screen, optical device, sensor, or other input device used with computers or in the teaching environment. The output device 106 may be a visual monitor, sound devices, or other devices used with computers or in the teaching environment.

In an exemplary embodiment of the invention, a computer program is provided, where the computer program is configured to generate a simulated interactive teaching environment. The simulated interactive teaching environment may be configured to present teachers with a simulated school program-like environment that includes a classroom, students, and a plurality of randomly generated classroom events that may detract from the health of the learning environment in the classroom. The randomly generated events may be predefined and stored in a database, and a control program for the simulation program of the invention may be configured to randomly select events from the database of events so that each simulation is different from other simulations. The simulated classroom environment allows users to address the randomly generated events with a plurality of options, such as making a classroom rule to address future events, taking a one time action to address the event, taking no action in response to the event, etc. Since the events are randomly generated, they occur in the same manner as a real classroom, and as such, the simulated environment of the invention offers teachers an opportunity to develop their classroom management skills in a non-classroom environment without negatively impacting a true classroom environment. Each response to the randomly generated event, which may be a disruptive event for the classroom or a non-disruptive event, that is made by the user of the simulation program is graded or rated (usually based upon predetermined parameters or ratings). The ratings or grading of the user's responses are used to score or grade the overall simulation success. The responses (or lack thereof), along with the timing of the responses, are also used to adjust variables representative of the overall classroom health that may be used to further judge the classroom management skills of the user.

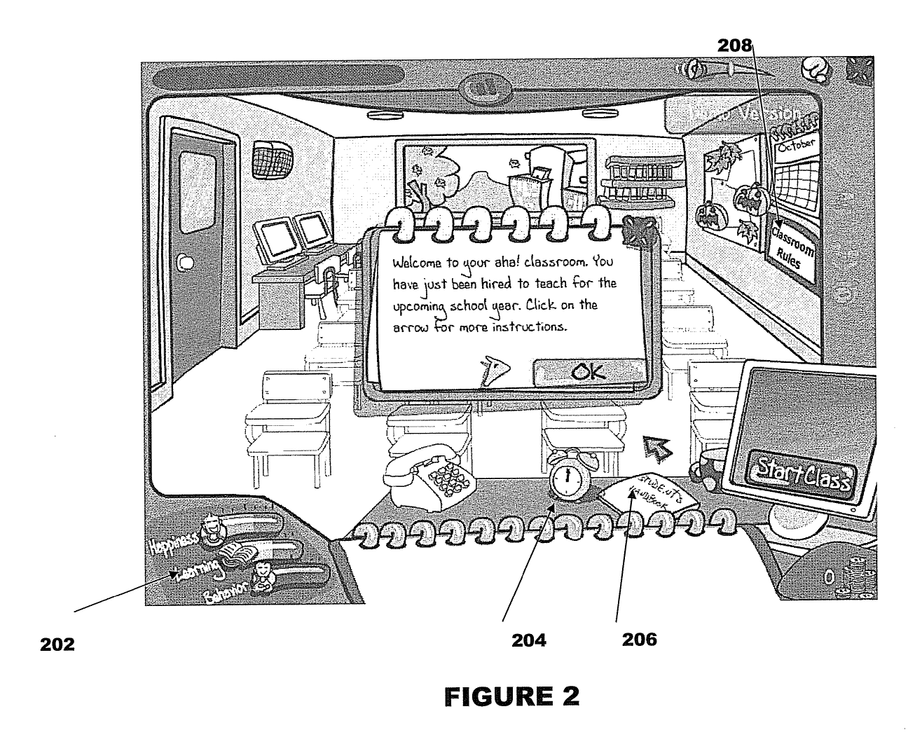

FIG. 2 illustrates a screen shot of an exemplary starting screen for the exemplary simulation program of the invention. However, Applicants note that embodiments of the invention are not limited to displaying on computer screens. Rather, embodiments of the invention may be displayed on various types of display devices that may be beneficial for simulations, such as plasma screens, televisions, holograms, 3D imaging technologies, etc. The simulation generally begins with an orientation period, wherein the user of the simulation is provided the opportunity to review student information, biographies, and profiles so that the user is familiar with each of the individual students that will be in the simulated class. The user is also afforded the opportunity to review current classroom rules and other materials, such as the student handbook and student biographical information contained in student profiles during the initial orientation period, and then set the classroom rules. Additionally, the orientation period is presented to the user in the classroom environment, i.e., in the same environment where the classroom simulation will occur, so that the user has the opportunity to familiarize themselves with the classroom environment before the actual interactive simulation begins.

The student profile may generally contain information about the students' parents and their parenting style, preferred discipline methods, preferred teaching methods, and/or other preferences related to the classroom experience each parent would like their child to receive to maximize their child's learning potential, which is intended to reflect actual circumstances faced by teachers in the classroom. It is important for the user of the simulation to review all of the information in the student profiles, handbook, and set the classroom rules, as responsive actions taken during the simulation that are not consistent with the information provided in the handbook, portfolios, and rules will have a negative impact on the score or rating of the simulation, as well as an impact upon the overall classroom health variables.

Therefore, the simulation not only grades the teachers on their ability to recognize and address both disruptive and non-disruptive events in the classroom environment, but the simulation also grades the manner in which teachers address the events. For example, if a teacher addresses an event in a manner that is inconsistent with a fact or piece of information contained in a particular student's biography or portfolio, then the teacher's grade for the simulation will be reduced. This portion of the simulation attempts to provide a comprehensive training to the teachers that emulates the real world classroom environment.

After the initial orientation period has ended, the user begins the simulation. The simulation may be presented to the user in the same manner as a normal school year, e.g., in academic quarters such as fall, winter pre-holiday, winter post-holiday, and spring. Other academic terms may be programmed into the simulation or selected by the user as required to train teaches for a particular jurisdiction or school district. During each quarter (term of the simulation), the user will be presented with a plurality of interactive classroom periods wherein a plurality of randomly generated classroom events will be presented in the simulation. The randomly generated classroom events are generally defined as events that occur in a normal classroom that may be disruptive to teaching. As such, a randomly generated classroom event may be a student talking to another student, a student talking out loud to one or more persons in the classroom, a student engaging in a classroom disruptive-type activity, a student engaging in an activity that may not be negative, but nonetheless is at least somewhat disruptive to the teaching process, a classroom interruption from an outside source, such as an intercom announcement, a knock on the door, an environmental event, or any other event that a teacher may encounter in a classroom environment. Thus, a randomly generated classroom event (which may be programmed or adjusted to suit the needs of any particular training scenario) may include any event that a teacher would normally encounter in a classroom environment that has an impact (either positive or negative) on the process or effectiveness of teaching, the learning taking place in the classroom, the happiness of the class, the behavior of the class, or any other measurable parameter that has an impact on a teacher's effectiveness or a classroom (including the students) health or happiness rating. Additionally, the simulated school quarter and class schedule may also provide the user of the simulation with a teacher's planning period at some time during the quarter. Further, at the end of each quarter, the user may receive a summary of the classroom performance that directly correlates to a rating or score for the simulation. The rating or score may then be used in a virtual school store to purchase teaching aids that facilitate the user obtaining a higher score in the subsequent quarter.

Returning to the exemplary simulation, the simulation will generally begin by presenting the user with an empty classroom and a set of basic operational instructions for the user, which may be the orientation period briefly discussed above. During the orientation period, the user may be presented with a limited amount of time (as represented by a ticking clock 204 that is audibly and/or visually presented to the user) to review the a student handbook 206, current classroom rules 208, and read the students' profiles to become more familiar with the students' interests, learning styles, abilities, etc. Additionally, during the orientation, the user may be presented with the opportunity to set initial classroom rules 208 for the simulated class. Each of these activities are optional, and the user may choose to start the class immediately without taking any of the above noted actions. After the clock stops ticking, a message shows on the screen urging the user to start the class. If, at the end of this allotted time, the user doesn't start the class by clicking the “Start Class” button, then the user's simulation score may be penalized.

In one embodiment, the user score or rating may include a learning indicator 202 that is representative of the quality of the learning environment of the simulated classroom. In this embodiment of the invention, when the user fails to start the simulation in a timely manner, the learning indicator 202 may be decreased, as instructional time is being wasted by the user not starting the class in a timely manner. This decrease in the learning indicator 202 may be directly reflected in the users rating or score for the simulation.

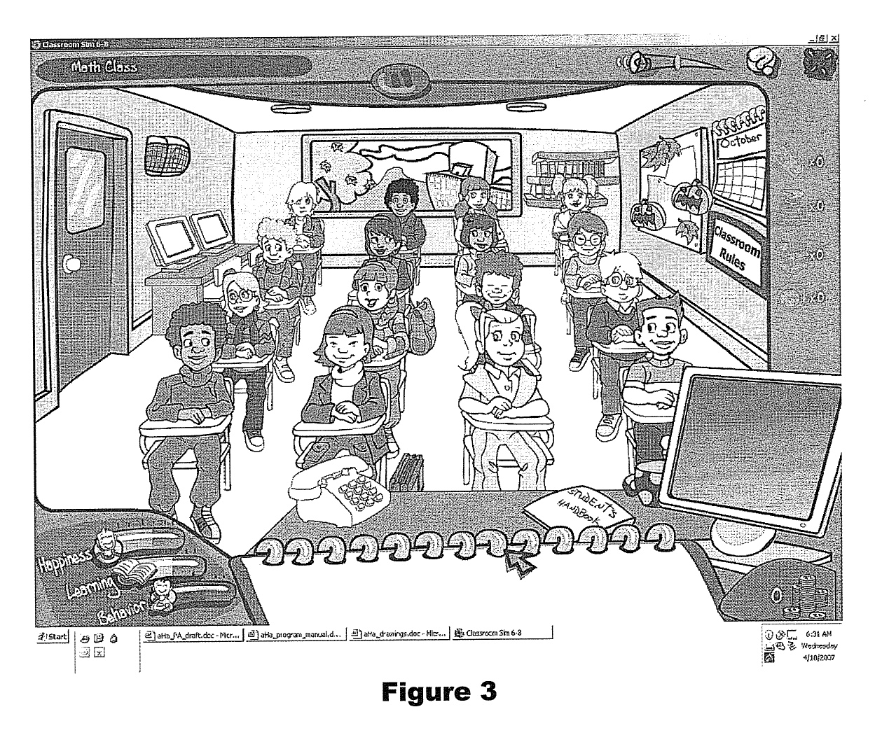

FIG. 3 illustrates a screen shot of an exemplary normal classroom period screen for the simulation program of the invention without any events taking place. The normal classroom period shows a simulated classroom environment having desks, chairs, students, computers, clocks, wall decorations, a window, a school intercom speaker, a classroom door for entry and exit, and other items that are normally found in a classroom environment. The simulation is shown to the user from the perspective of the teacher's desk. As such, the simulated classroom also shows the teachers desk, telephone, student handbook, a cup of coffee, the teachers computer screen on the desk, and the teacher's desk mat. Further, the normal classroom screen shot also includes the simulation user's score in the lower right hand corner and an illustration of the classroom measuring variables (shown as 202 in FIG. 2) in the lower left hand corner of the simulation.

The normal classroom environment simulation is where the majority of the randomly generated events (noted above) will occur. When these events occur, which are randomly generated by the program of the invention, the user will need to identify the behaviors that are deemed disruptive to the classroom environment and address them in a expeditious manner so that additional disruptive events are not missed and the classroom can return to a normal and productive learning state as soon as possible. Once a disruptive behavior is identified by the user in the simulated classroom, the user needs to click on the area where the disruptive behavior is taking place on the screen, which operates to identify to the program of the invention that the user has identified the disruptive event. Once the disruptive event has been identified, the user will generally be presented with a plurality of options for addressing the identified disruptive behavior. This may include at least one of creating a procedure (or rule) to address the type of disruptive behavior encountered and then globally applying the newly created procedure to all future classes. Another option may include applying a one-time procedure to correct the disruptive action without implementing a rule for future action. If a disruptive event occurs where the user has already created a procedure to address the particular type of disruptive event, then the user will be presented with the option to simply (and quickly) apply that existing procedure/rule, to modify the rule to improve the effectiveness or application of the already established procedure or rule, or to skip or not react to the identified disruptive event, i.e., ignore the identified disruptive event. Other possible choices that may be presented to the user may include ignoring the disruptive event, sending the student out of the classroom environment, referring the student to supervising official at the school (such as a principal), or taking any other action that a teacher would regularly take in addressing a disruptive event in a normal classroom environment.

However, each choice presented to the user has potential positive and/or negative impacts upon the classroom variables (shown as 202 in FIG. 2, for example). These variables, as noted above, generally represent the health of the classroom environment, and as such, each action (or lack of identifying and taking action) in response to a disruptive event may have an impact on the overall classroom health, as represented by the variables 202. For example, if a disruptive event is not addressed properly by the teacher (the user of the simulation), then the classroom heath variables will likely decrease, as the lack of adequately addressing the disruptive event would logically decrease the learning ability of the class, the behavior of the class, and the overall happiness of the class. Similarly, when the action in response to a disruptive event properly addresses a disruptive event, then the classroom health variables will likely increase, as the learning ability, behavior, and happiness of the class are improved when disruptive events are properly addressed by the teacher (user).

Thus, a focus of the simulation program of the present invention is not only to help teachers to identify and address disruptive events, but also to help teachers to take corrective action in response to disruptive events that will increase the overall health of their classroom. As such, although creating or changing procedures during the school year may have a short term negative impact on the classroom health indicators, ultimately these actions may help to prevent future disruptive behaviors and result in an overall long term improvement in the health indicators for the classroom.

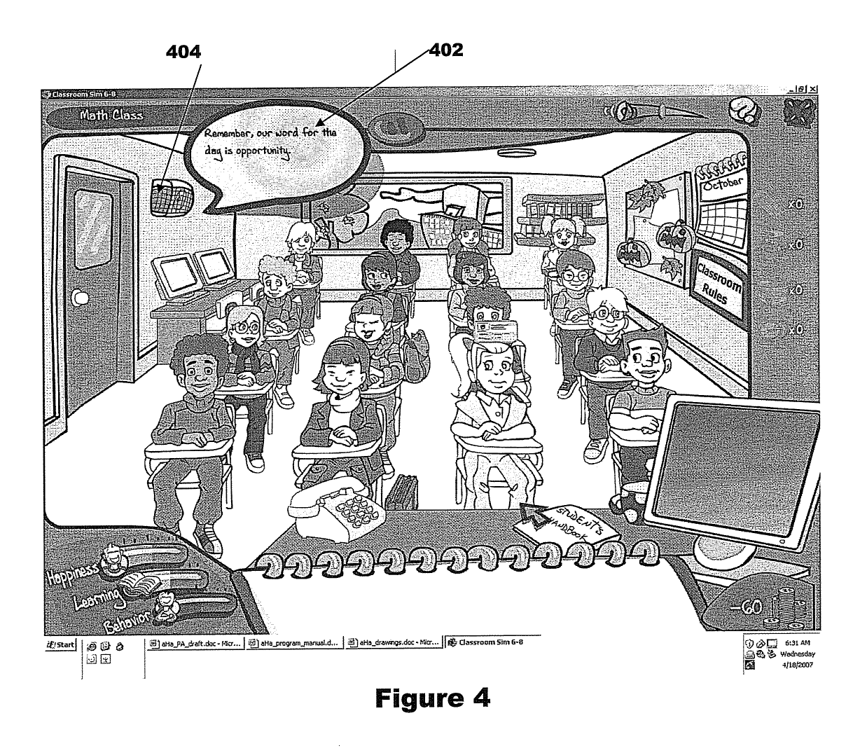

FIG. 4 illustrates a screen shot of an exemplary classroom period screen for the simulation program of the invention with an external event in process. The external disruptive event 402 is illustrated as an announcement from the school intercom system 404. The user of the simulation may identify the external event by clicking on the area proximate the event 402. Once the event is identified, the user may select an action to take in response to the event 402. In the case of an external event, and in particular, an intercom announcement, the user may choose not to identify the event 402, as the event may not qualify as a disruptive event. More particularly, when an event is selected or identified by the user that is not disruptive to the classroom environment, then the user is assessed a simulation penalty in the form of a time delay before the simulation may proceed. Although the assessment of a time delay does not directly impact the user's rating or score in the simulation, the user's score may ultimately be negatively impacted, as the user is not able to identify disruptive events during the time delay. Thus, the time delay operates in similar fashion to real life situations in that when a teacher is distracted by a non-disruptive event, the teacher is not able to identify and address disruptive events that may have a negative impact upon the overall health of the class.

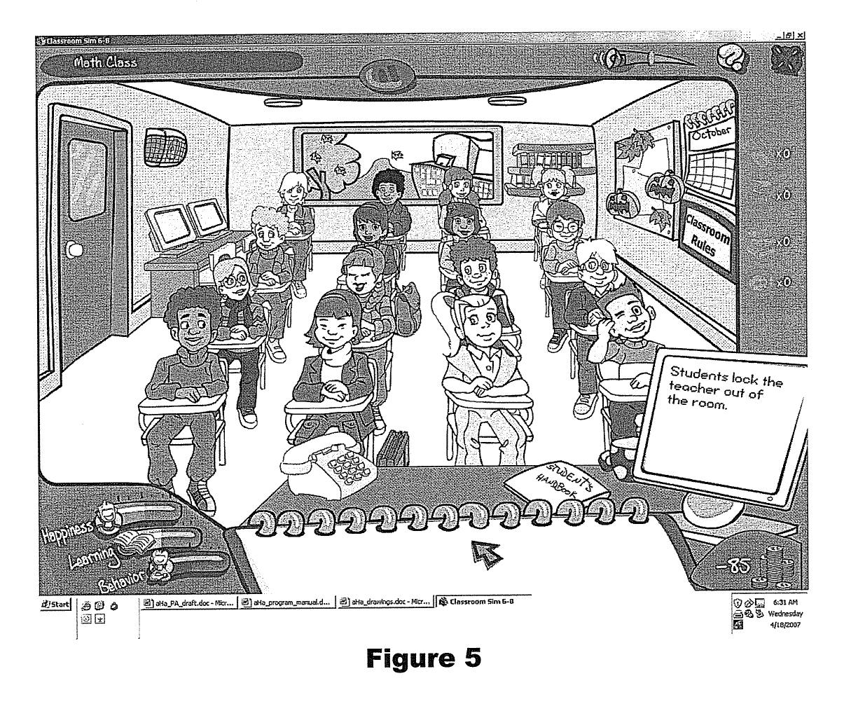

FIG. 5 illustrates a screen shot of an exemplary classroom period screen for the simulation program of the invention with a disruptive event noted on the teacher's computer monitor. Thus, FIG. 5 illustrates that the simulation program of the invention may generate a plurality of different disruptive events and present these events to the user in a plurality of ways, i.e., an event from a student action, an event from an external source (intercom, door knock, action outside the window, etc.), and also an event presented to the user on the simulated computer screen on the teacher's desk.

The disruptive events presented to the user may be randomly generated by the computer simulation program of the exemplary embodiment. For example, the exemplary software simulation program of the invention generally includes a computer processor. The processor may be in communication with a hard drive configured to store program information thereon, wherein the program information may be configured to control the operational characteristics of the simulation. The hard drive or other memory device in the computer may also be configured to contain a database of disruptive events associated with the simulation program of the invention. Thus, while the processor of the invention is running the simulation program, a random generating module in the software program may select a disruptive event from the database of events stored on the hard drive. The event may be pulled from the hard drive by the processor and presented to the user on the computer screen displaying the simulated classroom environment. The processor (in combination with the predefined software instructions that make up the simulation program) may be configured to randomly select events for each individual simulation, and as such, each simulation will generally be different from the one before and will not be repetitive.

In one exemplary embodiment of the invention, the choices presented to the user when a disruptive event is identified may also be predetermined in the software. For example, if a student yells in class, the program may be configured to give a particular set of response options to the user in response to the event, e.g., the response actions need not be randomly generated and are preferably predetermined per event so that the response is particularly relevant to the event.

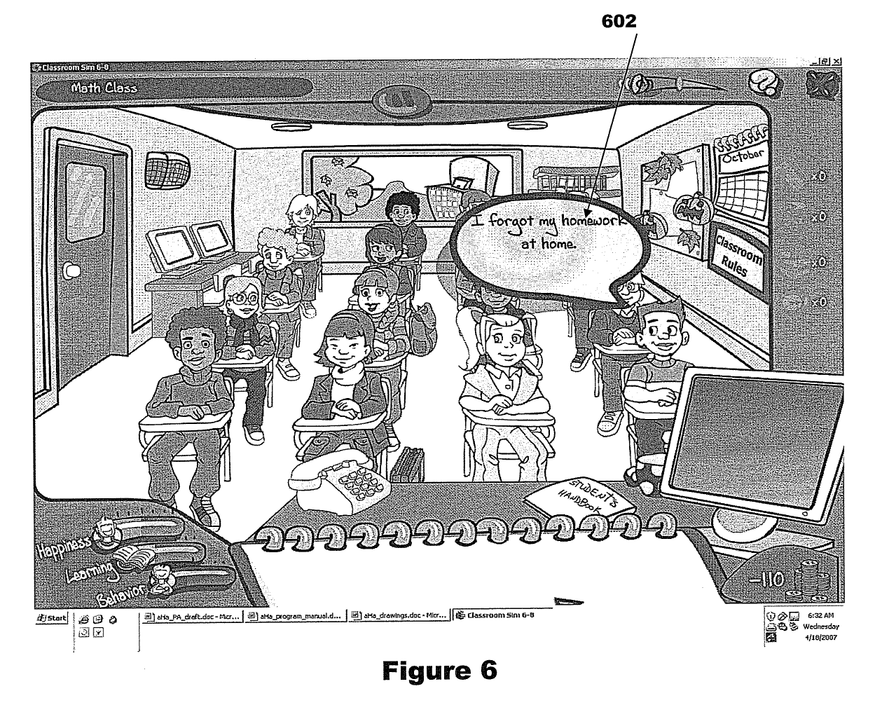

FIG. 6 illustrates a screen shot of an exemplary classroom period screen for the simulation program of the invention with a disruptive event 602 caused by a student being shown. The disruptive event 602, in the present example, is the student making a statement out loud. The statement is “I forgot my homework at home.” This particular disruptive event 602 is merely exemplary, as the simulation of the present invention may be configured to generate a plurality of disruptive events. Exemplary disruptive events by students include, but are not limited to speaking or shouting out loud, moving around the classroom without permission, falling asleep in class, interacting with another student in either a positive or negative manner, moving or throwing items in the classroom, and any other event that may be incurred by a teacher in a normal teaching environment.

When a particular disruptive event occurs, the user of the simulation should identify the event by clicking the computer mouse on the simulation screen proximate the disruptive event. Thus, identification of the disruptive event may be accomplished via the user's interaction with the simulation program itself. In one exemplary embodiment of the invention, the user may identify events by clicking on the event as it happens with a computer mouse that is in communication with the computer system running the program. In other embodiments of the invention, other computer input devices, such as pointers, interactive touch screens, keyboards, and other regularly used input devices, may be used in conjunction with a computer system to allow the user to identify disruptive events via interaction with the simulation program of the invention.

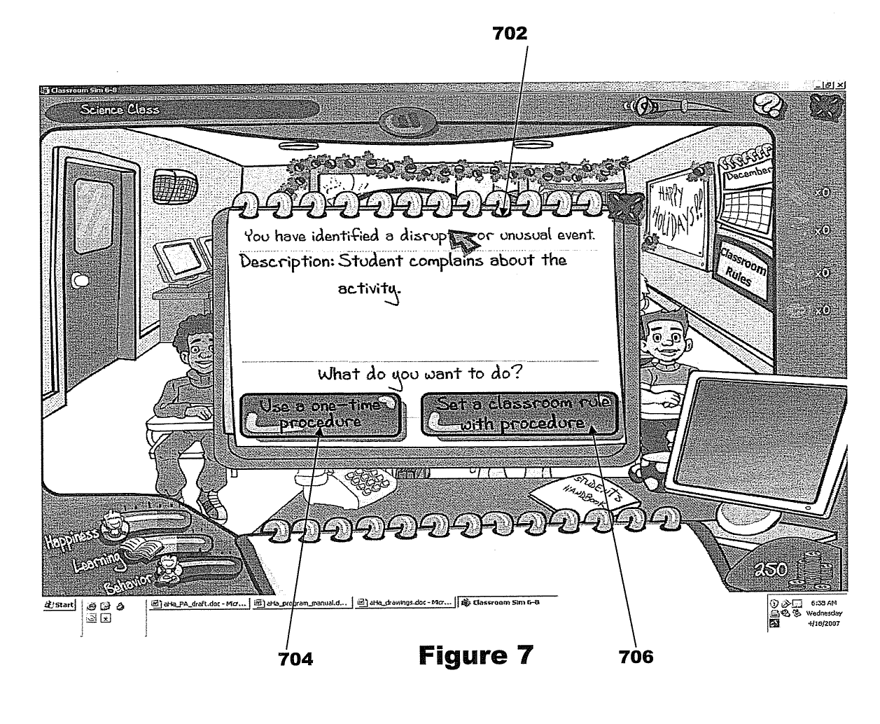

FIG. 7 illustrates a screen shot of an exemplary classroom period screen for the simulation program of the invention after the user has selected or identified a disruptive event. Once the disruptive event is identified by the user of the simulation, the user may be automatically presented with a plurality of responsive options. Therefore, once a disruptive event is identified, the simulation program halts the real time operation of the program for short period of time to present a decision window 702 to the user. The decision window 702 may generally present the user with a plurality of options for addressing the identified disruptive event. In the present exemplary embodiment, the decision window 702 provides two options: first, the option to use a one time procedure to address the disruptive event; and second, the option to create a classroom rule with a procedure calculated to address both the current disruptive event and future similar disruptive events.

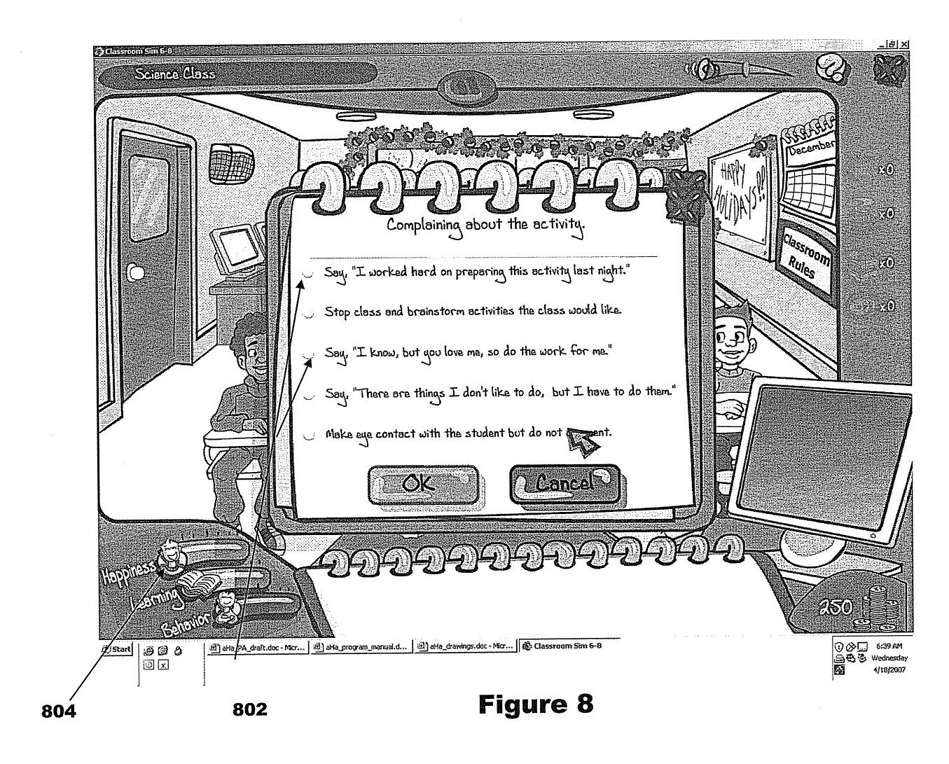

FIG. 8 illustrates a screen shot of an exemplary classroom period screen for the simulation program of the invention where the user has selected to respond to a disruptive event with a one time procedure (as shown in FIG. 7). When the user selects to apply a one time procedure in response to the identified disruptive event, a plurality of response options 802 may be presented to the user for selection. The user may select any of the options 802 to address the identified disruptive event. The option selected may have a positive or negative impact on one or more of the classroom health variables 804, which may be the happiness of the class, the learning ability of the class as a function of the learning environment, and the current behavior of the class. For example, if a selected response to a disruptive event is somewhat strict, then the learning variable may increase, but the happiness variable may decrease. Similarly, if a response is lax, then the learning variable may decrease, while the happiness variable increases. As such, the objective is to select a response option 802 that maximizes the overall health of the classroom by balancing the positive impacts of the response against the negative impacts of the selected response, as indicated by the variables 804.

However, one consideration that the user should keep in mind when selecting the “one time procedure” 704, is that the time during which the user is selecting which procedure to implement is lost time in the simulation, i.e., the time the user spends selecting the one time procedure co-exists with simulation time, i.e., the simulation does not stop while the user is selecting what action to take in the one time procedure. More particularly, the simulation may continue to run in the background of the computer screen during the one time procedure selection process. Thus, the user may miss other yet unidentified disruptive events happening in the classroom simulation while dealing with the selection of the one time procedure to address an already identified disruptive event, which may result in a lower score or rating and have a negative impact upon the classroom health variables 804. Therefore, although the one time procedure selection may be appropriate to address some disruptive events in a timely manner, the user should consider the negative implications of using one time procedures, e.g., consistent use of a one time procedure to address similar disruptive events indicates that a rule should have been created to maximize the simulation time and the ability to detect and address all of the disruptive events. In essence, this process facilitates the user increasing his/her classroom management skills.

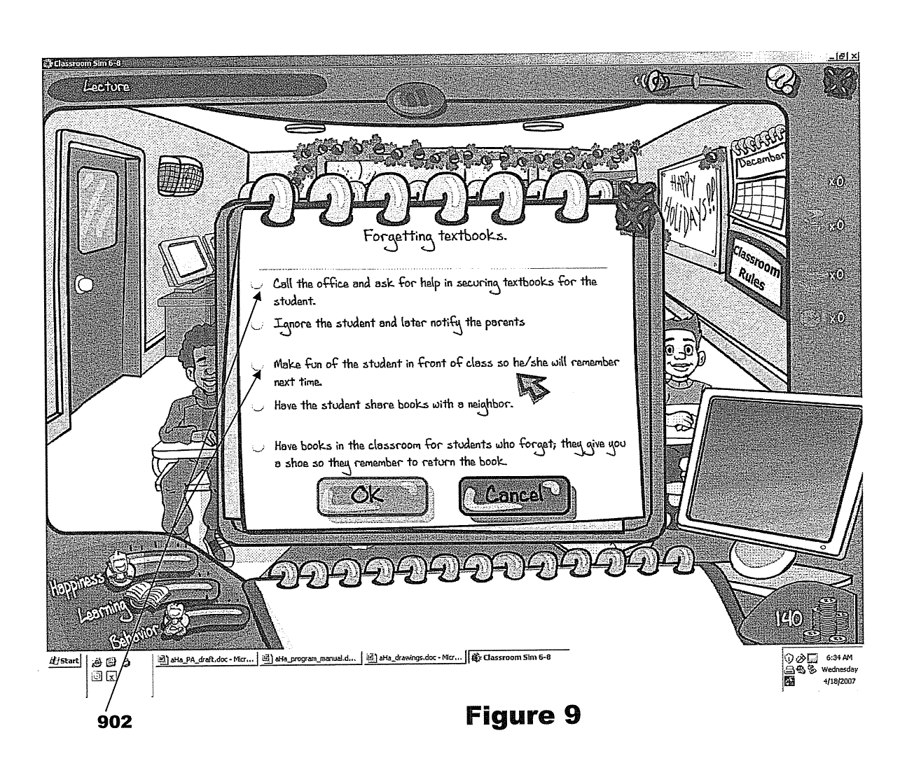

FIG. 9 illustrates a screen shot of an exemplary classroom period screen for the simulation program of the invention where the user has selected to respond to a disruptive event by making a rule (as shown in FIG. 7) to address similar future disruptive events. The possible rules 902 presented in the exemplary screen in FIG. 9 are rules related to a disruptive event where a student forgets a textbook. Therefore, whichever rule the user selects in response to the current event will be available to apply to future events in an expeditious manner. Therefore, although the process of making a precedent-type rule takes time away from the simulation, once the rule is created, it can be easily applied to future similar disruptive events without unnecessarily using up simulation time (which decreases the classroom health variables). In one exemplary embodiment of the invention, the simulation continues to run in the background while the user selects the rule to apply and add to the list of classroom rules. However, in another exemplary embodiment of the invention, the simulation may be paused while the user selects the appropriate rule to apply.

In an exemplary embodiment of the invention, once a classroom rule has been created by the user, the exemplary simulation program of the invention may be configured to automatically apply the rule to subsequent disruptive events identified by the user, when the identified disruptive event is sufficiently related to the previously defined rule. Therefore, the user may not be required to create a rule or apply a procedure to the identified disruptive event. Rather, once the disruptive event is identified, the user may simply select to apply the previously created rule and continue with the simulation without missing any simulation time (or disruptive events that could lower the classroom health indicators).

The exemplary simulation program of the invention may be configured to present the user with several classroom periods in a row to simulate a typical school day. Additionally, the exemplary simulation program of the present invention may be configured to provide a planning period to the user. The simulation user may also receive phone calls from parents during this period, where the parents express opinions on the users interaction and performance. For example, if a procedure or rule is applied to a student and the parents believe the application or process thereof was improper, the parents may call or otherwise contact the teacher to voice their concerns. In this scenario, the exemplary simulation program of the invention may be configured to present the user with a plurality of options (similar to the options presented in response to the disruptive events). The user can then select an option to respond to the parent's concern, and the user's selection may impact either the classroom health variables or the user's rating or score in the simulation. The planning period may also be used to review the student related materials, such as the portfolios, biographies, etc.

In another exemplary embodiment of the invention, the simulation program may be configured to add a teaching element to the simulation to further liken the simulation experience to a real world classroom environment. More particularly, the exemplary simulation program may be configured to present simple teaching tasks to the user of the simulation that may be accomplished while the simulation is running. This simulates the teacher having to focus not only on identifying disruptive events, but also on continuing to facilitate the overall objective, which is to teach the students. Therefore, the simulation program of the invention may be configured to require the user to interact with the simulation program in a manner that represents teaching. For example, the simulation may require the user to type short sentences or paragraphs representing the subject being taught. In one exemplary embodiment of the invention, the user may be prompted to type sentences or short answers, click on answers to educational questions, or take other action during the simulation to simulate teaching the class while also monitoring, identifying, and addressing disruptive events.

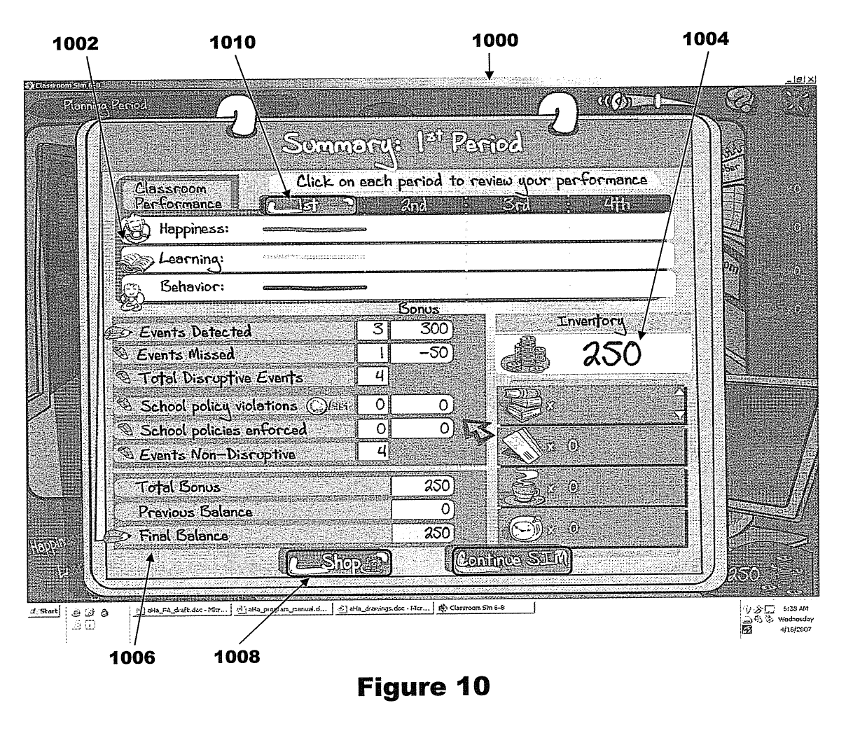

Once the user has completed a series of classes and an optional planning period, the user's performance in the simulation is rated and presented to the user for evaluation. FIG. 10 illustrates a screen shot of an exemplary classroom simulation performance summary for an embodiment of the invention. The summary 1000 includes a representation of the classroom health variables 1002 status after the most recent simulation has been completed. In the current embodiment, the simulation is divided into four quarters, as shown at 1010, and as such, the current summary 1000 summarizes the simulation for the first quarter, which is highlighted in the four quarters shown in 1010. The user's rating or score is shown at 1004 as 250. The score is calculated during the simulation and generally displayed to the user real time in the lower right hand corner of the simulation screen. The score is increased when the user takes action that is favorable to the classroom health variables. In another embodiment of the invention, the score may also be decreased when the user takes action (or omits an action) that results in a negative impact upon the classroom health variables. The score or rating is important to the simulation process, as once a segment or portion of the simulation is completed, the rating or score may be used to purchase teaching aids to be used in subsequent simulations, as will be further discussed herein. The summary 1000 also contains an itemized list of actions and omissions 1006 that occurred during the simulation. For example, the itemized list 1006 notes that there were 3 events detected, which resulted in 300 points or credits being added to the score or rating 1004. Similarly, there was one event that was undetected by the user, which resulted in a deduction of 50 points from the score or rating 1004. When the user clicks on the button to review each quarter in the list of quarters 1010, a new screen will appear that displays a list of the events that happened during the selected quarter, the courses of action taken, and the effects of the selected actions. The user can also see if any of his/her decisions violated a school policy so that those particular actions can be avoided in the future.

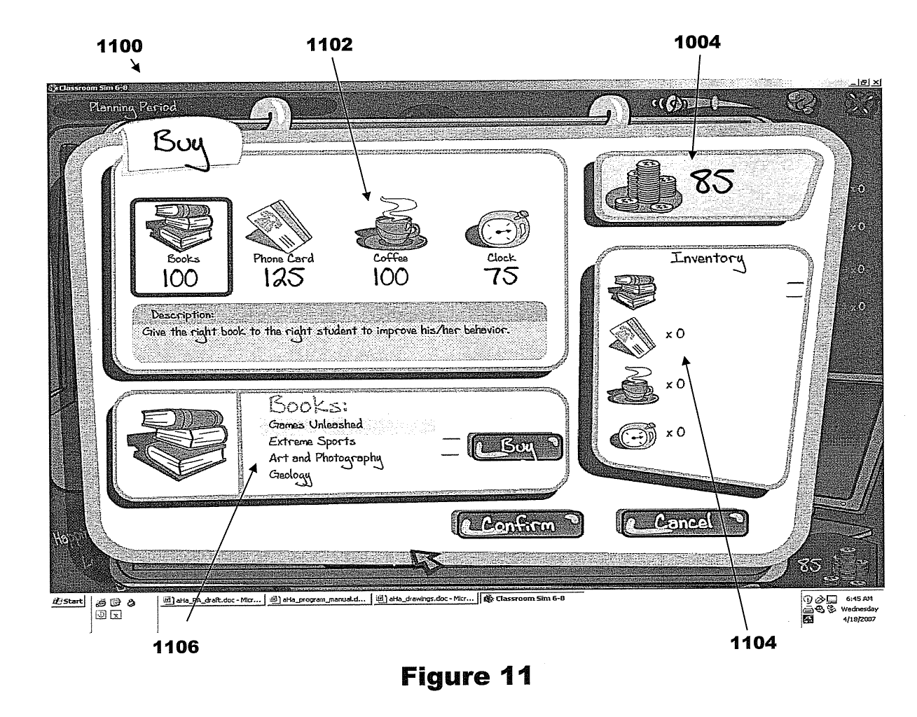

The user can select to use the score or rating 1004 to purchase teaching aid items by selecting the “shop” button 1008 at the bottom of the window. FIG. 11 illustrates a screen shot of an exemplary classroom store 1100 where the user is provided the opportunity to purchase items that will assist with the teaching process in the simulated classroom environment. The classroom store 1100 includes a plurality of teaching aid items 1102 that may be purchased. Exemplary items 1102 include books, phone cards, coffee, and a clock. The books may, for example, be given to the students to increase the learning and the happiness of the class. However, there are also different types of books to be purchased, as shown at 1106, and as such, the user must select books that are appropriate for each student. The determination of what book may be appropriate for each student may be made by referencing the students' profiles, where the students' interests are listed (this is available in the student handbook, and also may be available during the simulation by simply mousing over the student and reading the profile information that is presented in the pop-up window). When an appropriate book is presented to a student, the classroom health indicators may increase; however, if a book that is not appropriate for a student is presented (when a student is presented with a book that their profile indicates they are not interested in), then the classroom health indicators may decrease.

The user's rating or score is shown at 1004, and this may be used to purchase selected teaching aids, as indicated by the itemized purchase list at 1104. The user is allowed to use all of the rating or score to purchase whatever items they desire, or if none are desired, the user can simply continue with the next stage of the simulation. Another teaching aid that may be purchased in the store is the stopwatch. The stopwatch lets the teacher schedule a planning period on demand, which can be used in conjunction with the other items purchased at the store, i.e., to give a student a book to occupy them, to keep them from creating disruptive events, or to increase their happiness rating. Additionally, with regard to the books available in the store. the user can buy books that match his or her students' interests, and if a student receives a book that matches his or her interests, the next disruptive event the student may have caused during the simulation will automatically be addressed correctly, thus increasing the overall classroom health variables. Another item available to purchase in the store is coffee. The user can drink the coffee when he/she needs to select a course of action, and the coffee operates to delete the worst options presented for consideration, thus making it an easier and lower risk decision for the user. Another item that is available for purchase in the store is a phone card. Each phone card purchased allows the user to have a phone conference with a student's parents, which may result in improving the relationship with the parents, and as such, the parents may call less often to complain but more often to congratulate the teacher's decisions. These actions will have a positive impact on the overall classroom health variables.

Additionally, the software program of the invention may include several rules that are not readily apparent to the user. For example, the software may be configured to allow the addition of classroom rules after the orientation period. If the user adds classroom rules after the orientation period, the health indicators change but there may be no notification to the user. The happiness indicator will go down and the behavior indicator will go up, and this change in indicators signifies that while the classroom is taking some time to adjust to the new rule, but the behavior in the classroom has improved. Similarly, the software simulation program of the invention may also be configured such that the cost of making phone calls or giving items to students during regular class time is accounted. For example, the user can give books to the students or call the parents at any time during the simulation. However, if the user takes these actions during regular classroom time he or she will be penalized for wasting instructional time and the health indicators will drop. It is recommended to either wait for a planning period or to generate a planning period by using a stopwatch before performing these actions.

The software package of the invention may also provide a final evaluation or summary of the simulation. The final evaluation may be presented to the user at the end of the simulation and is generally representative of the user's overall performance, including number of credits obtained, number of credits used in the school store, and the final value of the classroom health indicators. If you choose to print your summary report, you will also see a listing of all events that occurred during the simulation, grouped by quarter. The user can utilize this report to reflect on his or her performance.

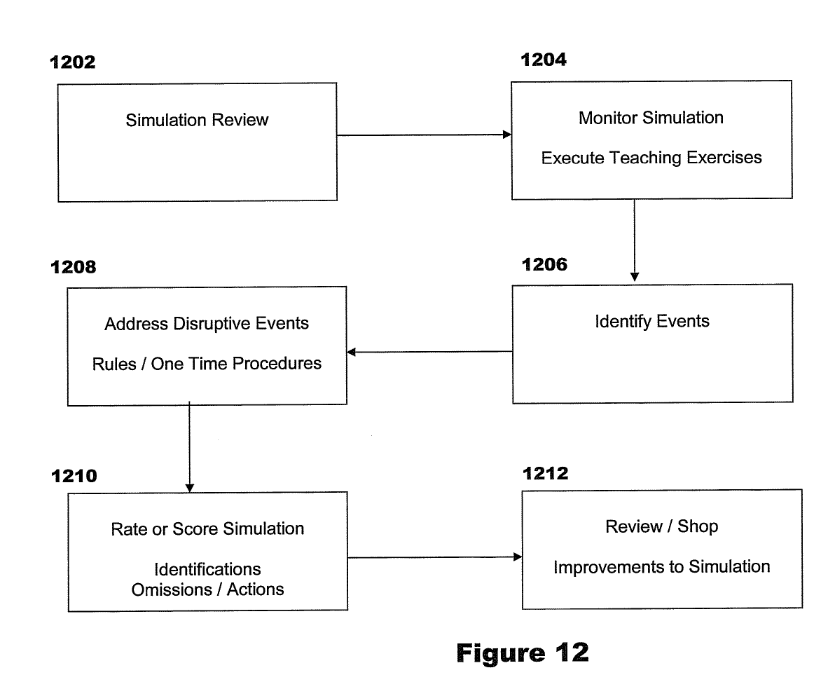

FIG. 12 illustrates a flowchart of an exemplary classroom simulation method of the invention. The exemplary classroom simulation method of the invention begins at step 1202 where the user is presented with a period of time to familiarize themselves with the simulation environment and to review documentation, biographies, portfolios, existing classroom rules, etc. This review allows the simulation user to come up to speed on all aspects of the classroom environment, including the individual needs of the respective students in the simulation class. Once the review period is concluded, the method continues to step 1204 were the classroom simulation begins.

Once the simulation begins, the user is presented with a classroom type environment to monitor for disruptive events. Additionally, exemplary embodiments of the present invention may provide a teaching simulation that not only requires the user to monitor the simulation for disruptive events, but also requires the user to execute teaching functions while monitoring the simulation. For example, the user may be required to respond to basic questions on the simulation screen, to interact with the simulation, to type responses to questions posed by the simulation program, or to take other interactive action with the simulation program to simulate the user conducting teaching functions in an actual classroom while simultaneously monitoring the classroom simulation environment for disruptive events.

Regardless of whether the particular embodiment employs methodology that requires the user to interact with the simulation program to represent teaching, once the simulation is active, one of the user's primary goals is to identify disruptive events taking place in the classroom simulation, as represented by step 1206. The user may generally identify disruptive events in the simulation by clicking on or near the disruptive event with the computer mouse. The action of clicking on the disruptive event indicates to the simulation program that the user has identified the disruptive event, and in response thereto, the program may proceed to the next step in the simulation method.

Once a disruptive event is identified by the user at step 1206, the method proceeds to step 1208 where the user takes action to address the identified disruptive event. The action taken in response to the identified disruptive event may be, for example, applying an existing classroom rule, applying a one-time procedure to address the disruptive event, ignoring the disruptive event, removing the student causing the disruptive event from the classroom simulation environment, or any other action programmed into the simulation. Generally, the simulation program of the present invention may be programmed to provide any number of options for addressing disruptive events to users. As such, other actions that may generally be taken by teachers in response to disruptive events, such as issuing a student and “timeout” or other type of disciplinary action, are all contemplated within the scope of the present invention and may be implemented into the computer simulation program.

The computer simulation program, in response to steps 1204, 1206, and 1208, rates or scores the user's performance in the classroom simulation environment. For example, the user's rating or score may be increased if the user identifies a disruptive event. However, if the user is distracted by other elements of the simulation, such as the teaching element or other activities taking place with the simulated students, and the user misses identification of a disruptive event, then the simulation rating or score for the user may be reduced accordingly. Further, once disruptive events are identified, the user's rating or score may be increased or decreased depending upon the particular action taken in response to the identified disruptive event. For example, if a student creates a disruptive event in the simulated classroom and the user identifies the event and takes corrective action that is not consistent with the student's biography information, then the user's rating or score may be decreased for taking action that may be deemed as inappropriate, as defined by the student profiles, biography information, predefined classroom rules, regulations, or other information presented to the user during the orientation portion of the simulation (step 1202).

The user continues through the simulation process for a predetermined period of time. The predetermined period of time for the simulation may include a plurality of simulated academic quarters, semesters, trimesters, or other time periods generally used in educational systems. Additionally, the simulation may be broken up into different classes containing different simulated students. As such, the user may proceed through a school day in a manner similar to that of an actual teacher in a classroom environment. For example, the teacher may first have an orientation period, and then teach a plurality of classes on different subjects, wherein each of the plurality of classes may include a plurality of different students therein. Regardless of the time periods used for the simulation, after a predetermined period of time, the simulation pauses and presents a summary of the user's performance for review and evaluation. An exemplary summary is shown in FIG. 10, and may include a summary of the actions taken during the simulation, a score or rating for the simulation, and one or more environmental ratings (see 1002 in FIG. 10, for example) reflective of the overall classroom health during the simulation.

Another feature of the exemplary simulation method of the invention may be that the review and evaluation step illustrated at 1212 may also include a shopping step. For example, referring to FIG. 10 at 1008, the user may select the “shop” button from the review screen and enter in to a shopping screen, as illustrated in FIG. 11. In the shopping screen, the user may purchase teaching aids to facilitate a better teaching environment with the score obtained in the previous simulation. Exemplary teaching aids that may be purchased to include books, phone cards, coffee, and a clock, for example. Once the user selects specific teaching aids for purchase, the user's score may be deducted an appropriate amount to reflect the purchase of the teaching aids, and the simulation program continues.

However, in the continuation of the simulation, the user may utilize the teaching aids purchased in the shopping screen to provide a better teaching environment. For example, the teacher may give a potentially disruptive student a book to read to productively occupy their time. This response will create a better learning environment while also increasing the happiness score in the simulated classroom environment. Thus, the teacher is rewarded for scoring well in the previous simulation by having the option to provide a book to the student, which results in a positive—positive impact on the overall classroom health. Conversely, if the teacher did not have the book to provide to the student, then the student would be more likely to cause a disruptive event and the teacher's options would generally be to implement a rule or one-time procedure, both of which may carry a negative impact on the happiness of the classroom, as students generally do not favor being disciplined. As such, the teacher's score in the previous simulation benefits them in the current simulation by all allowing them to purchase teaching aids with their previous score that allow the teacher to be more effective in the teaching environment.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A method for simulating a teaching environment for educational training, comprising:
displaying an empty simulated classroom environment for an orientation period;
displaying an occupied classroom environment for at least one classroom period;
generating and displaying a plurality of disruptive events during the at least one classroom period;
identifying at least one of the plurality disruptive events on a display;
addressing the at least one identified disruptive event;
scoring training performance for the simulated teaching environment based on the identifying and addressing actions; and
using a score representative of the training performance to add enhancements to a subsequent teaching simulation.

2. The method of claim 1, wherein the displaying steps are shown from a teacher's desk perspective.

3. The method of claim 1, wherein the generating step comprises randomly selecting a disruptive event from a predefined database of disruptive events.

4. The method of claim 3, wherein identifying at least one of the plurality disruptive events on a display comprises selecting the disruptive event on a computer screen with a computer mouse or pointing device in communication with a computer.

5. The method of claim 4, wherein addressing the at least one identified disruptive event comprises:
implementing a one-time procedure to address the identified disruptive event;
applying a predefined rule to address the identified disruptive event; or
ignoring the identified disruptive event.

6. The method of claim 4, wherein scoring training performance based on the identifying and addressing actions comprises:
increasing a user score for each identified disruptive event; and
decreasing the user score for each disruptive event that passes unidentified.

7. The method of claim 6, further comprising:
increasing the user score when a rule is applied to a disruptive event and when the application of the rule is consistent with biography information for a student causing the disruptive event; and
decreasing the user score when the rule is applied to the disruptive event and when the application of the rule is not consistent with biography information for a student causing the disruptive event.

8. The method of claim 7, wherein the enhancements comprise elements that may be used to stop or calm an identified disruptive event without application of a rule or procedure and without decreasing the user score.

9. The method of claim 1, further comprising displaying an interactive teaching element to the user during the process of displaying the occupied classroom environment, the interactive teaching element requiring the user to interact with the element while simultaneously monitoring the simulation for disruptive events to identify.

10. A computer program embodied on a computer readable medium, that when executed by a processor, is configured to control a method for generating a teaching environment simulation, comprising:
displaying an empty simulated classroom environment for an orientation period;
displaying an occupied classroom environment for at least one classroom period;
generating and displaying a plurality of disruptive events during the at least one classroom period;
identifying at least one of the plurality disruptive events on a display by selecting the identified disruptive event with a pointing device;
addressing the at least one identified disruptive event with a rule, procedure, or enhancement element;
scoring training performance for the simulated teaching environment based on the identifying and addressing actions; and
using a score representative of the training performance to add additional enhancement elements to a subsequent teaching simulation.

11. The computer program of claim 10, further comprising:
the displaying steps comprise showing the simulation from a teacher's desk perspective;
the generating step comprises randomly selecting a disruptive event from a predefined database of disruptive events; and
the step of identifying at least one of the plurality disruptive events on a display comprises selecting the disruptive event on a computer screen with a computer mouse or pointing device in communication with a computer.

12. The computer program of claim 11, further comprising the addressing of the at least one identified disruptive event comprising implementing a one-time procedure to address the identified disruptive event, applying a predefined rule to address the identified disruptive event, or ignoring the identified disruptive event.

13. The computer program of claim 12, wherein scoring training performance based on the identifying and addressing actions comprises:
increasing a user score for each identified disruptive event;
decreasing the user score for each disruptive event that passes unidentified;
increasing the user score when a rule is applied to a disruptive event and when the application of the rule is consistent with biography information for a student causing the disruptive event; and
decreasing the user score when the rule is applied to the disruptive event and when the application of the rule is not consistent with biography information for a student causing the disruptive event.

14. The computer program of claim 10, further comprising displaying an interactive teaching element to the user during the process of displaying the occupied classroom environment, the interactive teaching element requiring the user to interact with the element while simultaneously monitoring the simulation for disruptive events to identify.

15. A system for providing an interactive teacher training simulation, comprising:
a computer processor;
a display in communication with the processor;
a pointing device in communication with the processor;
at least one memory element configured to store digital data; and
a computer program stored on the at least one memory element and configured to be executed by the computer processor to display an interactive teaching simulation, the interactive teaching simulation being configured to display a simulated classroom on the display, randomly generate disruptive events for display; receive an input indicating a user's identification of the randomly generated disruptive events, receive an input from the user indicating an action selected in response to the identified disruptive event, and to calculate a user score based upon the number of disruptive events identified verses the number of disruptive events that were not identified by the user and the corrective action selected by the user in response to the identified disruptive events.

16. The system of claim 15, further comprising generating an interactive teaching element to be displayed to the user during the simulation, the teaching element requiring input from the user and causing the score to reduce if the user fails to interact in a timely manner.

17. The system of claim 15, wherein the action taken comprises:
selecting a one time procedure to address the identified disruptive event;
applying an existing rule to the identified disruptive event; or
ignoring the disruptive event.
